(19) United States
(12) Patent Application Publication
(10) Pub. No.: US 2022/0266430 A1
(43) Pub. Date: Aug. 25, 2022

(54) Removal Tool for Push-to-Connect Fittings

(71) Applicant: Richard Warren, Rowlett, TX (US)

(72) Inventor: Richard Warren, Rowlett, TX (US)

(21) Appl. No.: 17/399,111

(22) Filed: Aug. 11, 2021

Related U.S. Application Data
(60) Provisional application No. 63/152,893, filed on Feb. 24, 2021.

(51) Int. Cl. B25B 27/02

(52) U.S. Cl. CPC B25B 27/02; F16L 37/04

(57) ABSTRACT

Current EvoPEX connector fittings offer numerous advantages over brass fitting counterparts. However, EvoPEX connector fitting's non-removable design can lead to increased labor and costs. The proposed removal tool is designed to remove push-to-connect fittings from various fluid conduits and includes an external malleable clamping flange and an internal metallic release sheet, adaptable for sealing engagement with a fluid conduit outer wall. Once the metallic release sheet circumscribes the appropriate, fluid conduit, the user pivotally slides the conduit removal tool laterally toward the EvoPEX connector fitting. Insertion of the metallic release sheet between the fluid conduit and the EvoPEX connector fitting depresses the internal locking collar. This depression mechanism prevents structural damage to PEX fluid conduit, thereby permitting reuse of the associated fluid conduit as not previously possible. Once inserted, the user may mechanically decouple the EvoPEX connector fitting from the fluid conduit through manual separation.

### CROSS-REFERENCE TO RELATED APPLICATIONS

The application claims the benefit of U.S. Provisional Application No. 63/152,893 filed on Feb. 24, 2021.

### TECHNICAL FIELD

The present invention relates to a conduit removal tool for decoupling push-to-connect fittings from at least a PEX, copper, or CPVC fluid conduit with the same or similar external dimensions through mechanical manipulation of variable internal locking mechanisms engaged along the longitudinal axis of said fluid conduit.

### BACKGROUND

Creating and maintaining plumbing systems requires use of many different components and tools. However, as the industry grows, independent development of new components remains problematic when it comes to the complimentary nature of the tools. One of the best and most cost-efficient solutions is component versatility, wherein one tool or component can be used with more than one type of material or tool, such as PEX, copper or CPVC piping. Other desired features are ease of use and increased reliability, without compromising attributes like optimal installation and efficiency.

SharkBite Plumbing Systems (“SharkBite”) recently developed a more stable and reliable fitting for use with at least PEX tubing that can withstand fluctuating water pressure, pulsation, and water hammer in response to environmental perturbations. The SharkBite EvoPEX push-to-connect fittings (“EvoPEX”) were designed specifically to connect PEX, or crosslinked polyethylene, tubing members.

The increased tolerance of SharkBite's EvoPEX complements PEX tubing integrity, thereby ensuring a plumbing system able to maintain its structural integrity that is less susceptible to harsh conditions. Unlike traditional brass fittings and tubing, the EvoPEX and PEX tubing combination offers higher resistance to pipe bursting, better flexibility, and less installation time. However, with versatility often comes increased costs and other inconveniences.

While the EvoPEX fittings offer greater assurances and flexibility, there remains a downside. SharkBite's EvoPEX fittings, unlike their brass counterparts, presently cannot be removed once coupled to the PEX tubing due to the mechanics of the internal locking mechanism. Because of this irreversible design, the proximal PEX tubing may only be used once, and users will have to purchase and install additional PEX tubing material anytime changes are made to the adjacent plumbing components, thereby increasing costs and labor. The current PVC-lock removal tools on the market are not designed to reliably remove EvoPEX fittings and they are not advertised to offer said functionality. The present invention further described below overcomes the above inconvenient and costly limitations by facilitating removal of the EvoPEX fitting from variably sized PEX, copper, or CPVC fluid conduits without damaging or otherwise compromising the structural integrity of the corresponding fluid conduits. Further, the present invention may facilitate removal of connector fittings other than an EvoPEX connector fitting as used by way of example below.

Additionally, the present invention described further below is manufactured for removing alternative push-to-connect fittings using like or similar methods as those described below for EvoPEX push-to-connect fittings. Alternatively, the present invention further described below offers a clipping function when mounted about the external surface of a PEX, copper, or CPVC tubing member.

### OBJECTS OF THE INVENTION

A primary object of the present invention is to facilitate pivotal disconnection of variable push-to-connect fittings from at least a PEX, copper, or CPVC fluid conduit;

It is another object of the conduit removal tool to promote slidable detachment without compromising the structural integrity of the variable fluid conduits; and

It is another object of the conduit removal tool to facilitate the removal of push-to-connect fittings using various iterations of EvoPEX and other push-to-connect fitting removal tools adapted for a plurality of complementary at least PEX, copper, and CPVC tubing member sizes.

### SUMMARY OF THE INVENTION

The following presents a simplified summary of the disclosed embodiments in order to provide a basic understanding of such embodiments. This summary is not an extensive overview of all contemplated embodiments and is intended to neither identify key or critical elements nor delineate the scope of such embodiments. Its sole purpose is to present concepts of the disclosed embodiments in a simplified form as a prelude to the more detailed description that is presented later.

The present invention proposes a conduit removal tool containing a fluid conduit retaining area for decoupling EvoPEX push-to-connect fittings from complementary variably sized PEX, copper, or CPVC fluid conduits. The current grasping mechanisms of the EvoPEX connector fitting are comprised of an irreversible internal locking feature. The present invention circumvents this limitation by offering a means for decoupling said push-to-connect fittings affixed to variably sized fluid conduits without compromising the structural and mechanical integrity of the corresponding fluid conduit.

The present invention presents a novel means tor decoupling at least SharkBite's EvoPEX and other push-to-connect fittings from at least PEX, copper, and CPVC fluid conduits using an adaptable hand-held conduit removal tool. Another novel feature of the present invention is its adaptability to a plurality of diverse fluid conduits, like at least PEX, copper, and CPVC. Whereas today's various PVC-lock removal tools are limited to PVC fluid conduit iterations, the proposed invention is designed to facilitate removal of at least all SharkBite and similarly designed push-to-connect fittings from either PEX, copper, or CPVC fluid conduits through disengagement of at least the interlocking mechanisms or depressing of collars manufactured on various push-to-connect fittings. Thus, the present invention discloses a novel and versatile tool for removing push-to-connect connector fittings from a diverse plurality of fluid conduits, including the removal of the EvoPEX push-to-connect fitting from at least PEX, copper, and CPVC tubing.

Other features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing summary, as well as the following detailed description of the invention, is better understood when read in conjunction with the appended drawings. For the purposes of illustrating the invention, exemplary constructions of the invention are shown in the drawings. However, the invention is not limited to the specific processes disclosed herein. The description of a process by a numeral in a drawing is applicable to the description of that process step shown by that same numeral in any subsequent drawing herein.

FIG. 1 through FIG. 7 relate to a push-to-connect fitting removal through release of the appropriate internal interlocking mechanism.

FIG. 1 shows removal tool design complimentary to the corresponding fluid conduit.

FIG. 2 shows the adaptive and malleable structure of the conduit removal tool.

FIG. 3 shows the mechanical connection of the conduit removal tool with the corresponding fluid conduit.

FIG. 4 shows the slidable insertion of the removal tool and corresponding fluid conduit into the EvoPEX connector fitting.

FIG. 5 shows the longitudinal rotation of the removal tool for depressing the internal teeth “collar” of the EvoPEX, thereby decoupling the EvoPEX connector fitting from at least the PEX, copper, or CPVC tubing member without damaging the structural integrity of the corresponding fluid conduit.

FIG. 6 shows manual decoupling of the EvoPEX connector fitting from the corresponding fluid conduit through lateral separation.

FIG. 7 shows a cross-section view of the removal tool.

FIG. 8 shows the novel dimensions of the removal tool specifically manufactured to complement various EvoPEX connector and their complementary fluid conduits.

### SPECIFICATION

For the present application, the phrases “connected to,” “coupled with,” and “in communication with” refer to any form of interaction between the EvoPEX or other connector fittings and the corresponding fluid conduit. The phrase “slidably attached to” or “pivotally attached to” refers to forms of mechanical coupling that permit relative rotation or relative translation. Although the following description discloses use of the present invention with an EvoPEX connector fitting, it is by no means intended to limit use of the invention with other connector fittings used for coupling complimentary fluid conduits.

The present invention includes a conduit removal tool adaptable to a plurality of fluid conduits such that each iteration of the conduit removal tool may accommodate a complementary fluid conduit and the corresponding EvoPEX connector fitting. In one embodiment, the conduit removal tool is comprised of molded clamping flange 1 mechanically coupled to the exterior of metallic release sheet 2 comprising at least a stainless-steel medium. In one embodiment, molded clamping flange 1 is made of elastomeric material. Although the present embodiment comprises molded clamping flange 1 using an elastomeric medium, it can be appreciated in the art that various other malleable materials may be used. Both molded clamping flange 1 and metallic release sheet 2 are manufactured in a semi-circular manner, producing aperture 3 adapted for sealing engagement of a plurality of fluid conduits differing in diameter, such as fluid conduit 4.

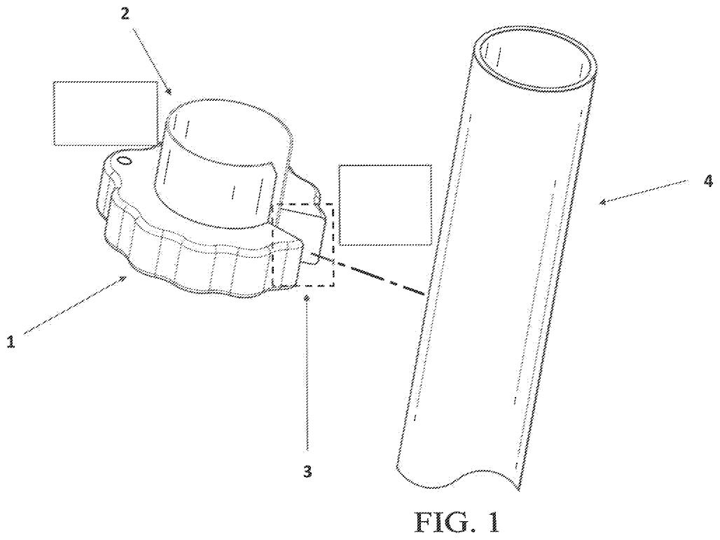

Referring to FIG. 1, in one embodiment, the structure of the conduit removal tool may circumscribe the perimeter of corresponding fluid conduit 4 by fully inserting fluid conduit 4 through aperture 3. Insertion of fluid conduit 4 through aperture 3 promotes a sealing engagement for a plurality of fluid conduits. In one embodiment, the conduit removal tool is adaptable to a one-half inch fluid conduit and the corresponding EvoPEX connector fitting. In another embodiment, the conduit removal tool is adaptable to a three-quarter inch fluid conduit.

In another embodiment, metallic release sheet 2 can be pivotally coupled to the external perimeter of a PEX fluid conduit. In another embodiment, metallic release sheet 2 is pivotally coupled to the external perimeter of a copper fluid conduit. In another embodiment, the fluid conduit is comprised of CPVC fluid conduit. In yet another embodiment, the fluid conduit is comprised of tubing material other than PEX, copper, or CPVC. The structural adaptability of the conduit removal tool for sealing engagement with a plurality of variably size fluid conduits offers an improvement to the current art wherein current removal tools are limited by tubing material, connector fitting, and other limiting features.

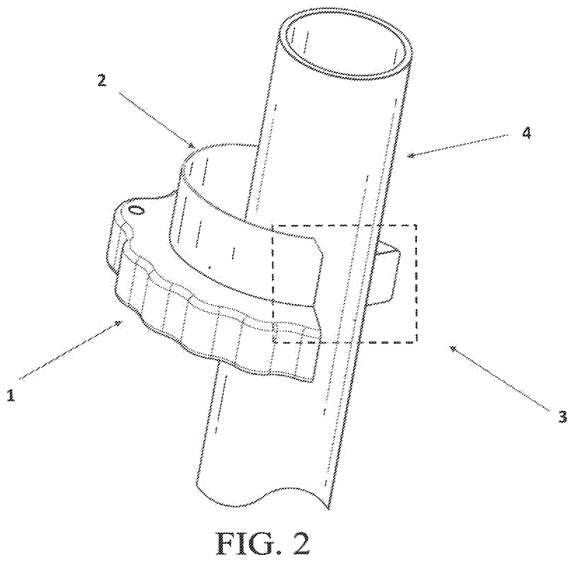

Referring to FIG. 2, the user adapts molded clamping flange 1 dimensions to the diameter of fluid conduit 4 by compressing mechanically fluid molded clamping flange 1 using at least the user's index finger and thumb. In one embodiment, the user's mechanical force applied to molded clamping flange 1 manipulates the circumference of the conduit removal tool such that it adapts to the diameter of corresponding fluid conduit 4, thereby facilitating mechanical engagement between the outer surface of fluid conduit 4 and the interior of molded clamping flange 1. In one embodiment, the user inserts corresponding fluid conduit 4 through aperture 3, wherein the adaptability of the conduit removal tool facilitates the insertion of corresponding fluid conduit 4 by manipulating the conduit removal tool circumference to form a sealing engagement between molded clamping flange 1 and a plurality of variably sized fluid conduits.

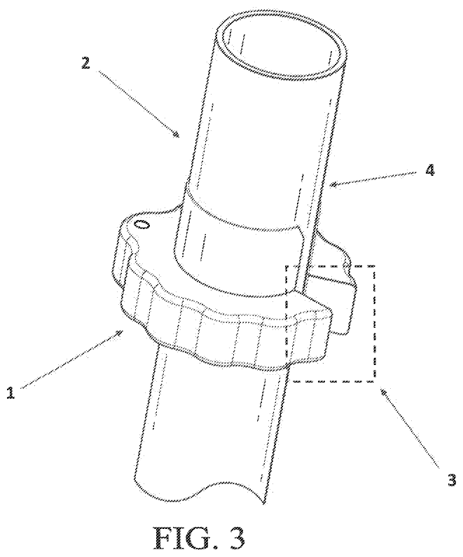

Referring to FIG. 3, the user slidably attaches molded clamping flange 1 to fluid conduit 4 by inserting corresponding fluid conduit 4 through aperture 3. The slidable attachment of the conduit removal tool around the exterior perimeter of corresponding fluid conduit 4 is dependent on mechanical manipulation of molded clamping flange 1 and metallic release sheet 2 dimensions adaptable to a plurality of corresponding fluid conduits 4.

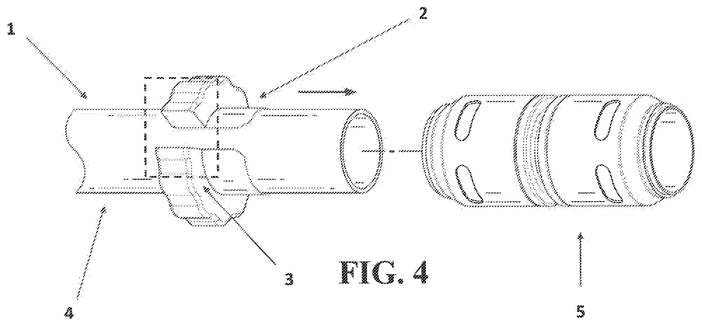

Referring to FIG. 4, in one embodiment, the user inserts metallic release sheet 2 into EvoPEX connector fitting 5 connection chamber by laterally sliding metallic release sheet 2 along corresponding PEX, copper, or CPVC fluid conduit 4 toward the point of communication with EvoPEX connector fitting 5. In one embodiment, the user slidably inserts metallic release sheet 2 into the connection chamber to the point of communication with the internal grasping mechanism and thereafter further inserts metallic release sheet 2 into the connection chamber an additional distance tailored to the variably sized push-to-connect connector fittings, such as at least 1/16 inch. Full insertion of metallic release sheet 2 between EvoPEX connector fitting 5 and corresponding fluid conduit 4 promotes release of the internal grasping mechanism via mechanical depression of the internal teeth “collar,” thereby decoupling the interior grasping mechanism engaging EvoPEX connector fitting 5 with the external perimeter of fluid conduit 4 and permitting pivotal translation of the proximal end of corresponding fluid conduit 4.

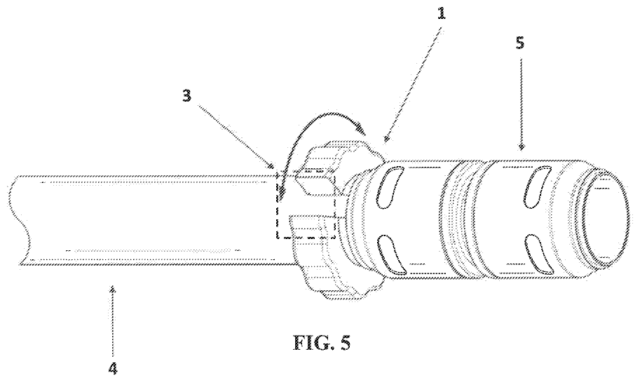

Referring to FIG. 5, in one embodiment, the user inserts metallic release sheet 3 between EvoPEX connector fitting 5 and corresponding fluid conduit 4 and pivotally rotates the conduit removal tool 180 degrees around the exterior of corresponding fluid conduit 4 then coupled to EvoPEX connector fitting 5. In one embodiment, the 180-degree pivotal rotation promotes decoupling of EvoPEX connector fitting 5 by depressing the teeth “collar” in the EvoPEX connector fitting 5 connection chamber.

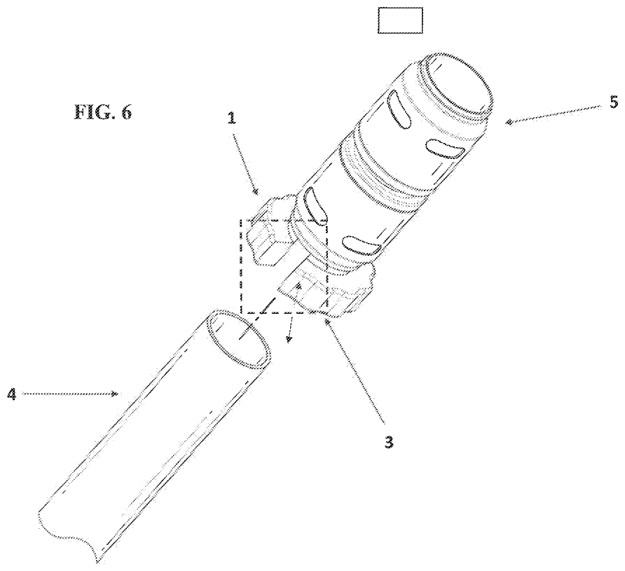

Referring to FIG. 6, in another embodiment, the user inserts metallic release sheet 2 between EvoPEX connector fitting 5 and corresponding fluid conduit 4, and mechanically separates corresponding fluid conduit 4 from EvoPEX connector fitting 5 by pulling the respective parts in opposite directions. This mechanical separation actuates disconnection without damaging the integrity of the corresponding fluid conduit 4.

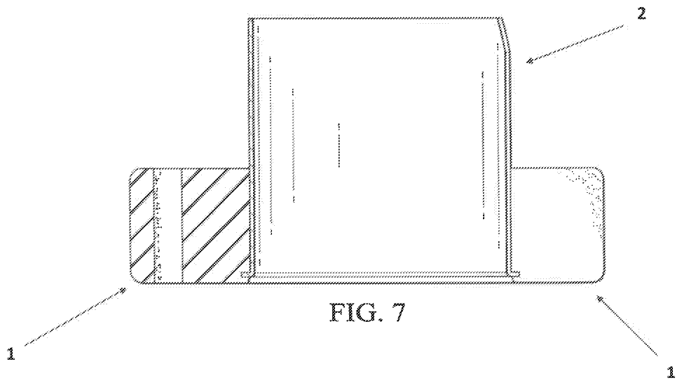

Referring to FIG. 7, the conduit removal tool is manufactured in a manner such that it can be inserted between EvoPEX connector fitting 5 and corresponding fluid conduit 4. Additionally, the removal tool is manufactured in a manner facilitating mechanical separation through release of EvoPEX connector fitting 5 internal collar.

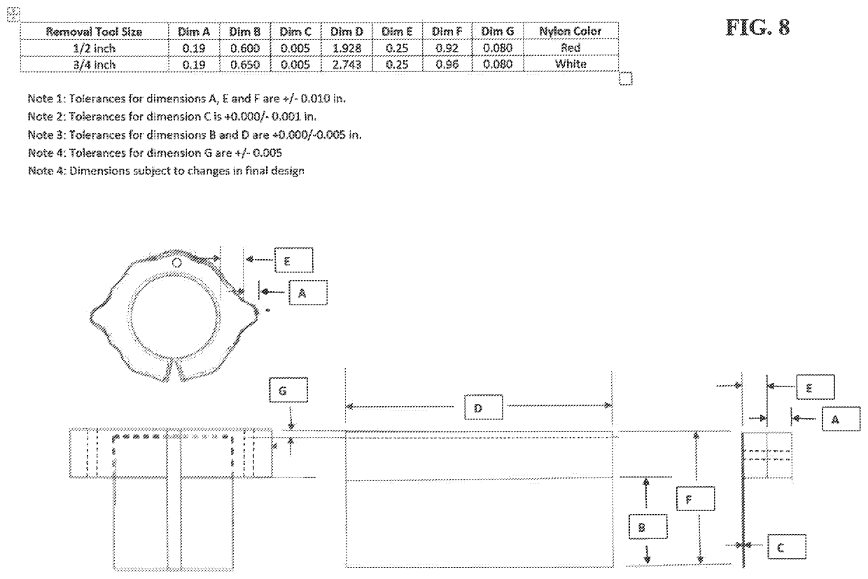

Referring to FIG. 8, in at least two iterations of the preferred embodiment, the removal tool dimensions are manufactured in a manner that permits coupling with the various complimentary fluid conduits. The optimal dimensions offered by the present invention constitute an improvement on the current art by facilitating reuse of complementary fluid conduits in various mediums following previous communication with once irreversible EvoPEX connector fittings.

Preferred embodiments of this invention are described herein, including the best mode known to the inventors for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the within disclosures are exemplary only, and that various other alternatives, adaptions, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings in the foregoing descriptions. Although specific terms may be employed herein, they are used only in a generic and descriptive sense and not for purposes of limitation. Accordingly, the present invention is not limited to the specific embodiments illustrated herein.

1. An apparatus for dislodging an at least one complimentary fluid conduit from a connector-fitting attachment chamber, the apparatus comprising:
a rotatable semi-circular insertion device;
a gripping portion connected to one end of said insertion device;
a second end of said insertion device adjacent said gripping portion consisting of a malleable surface wherein said malleable surface is capable of adaptable engagement with at least one complimentary fluid conduit and connector-fitting along its longitudinal axis;
said locking mechanism released when connectively engaged by said insertion device.

2. The apparatus of claim 1 wherein the connector-fitting comprises at least one internal locking mechanism capable of receiving said insertion device.

3. The apparatus of claim 1 wherein the malleable surface is selected from the group consisting of steel, aluminum, tin, and plastic.

4. The apparatus of claim 1 wherein the gripping portion is elastomeric.

5. The apparatus of claim 1 wherein the said malleable surface of said rotatable semi-circular insertion device folds around at least one half of the diameter of said fluid conduit such that it is near flush with said connector-fitting prior to insertion.

6. The apparatus of claim 1 wherein said connector-fitting is a SharkBite EvoPEX.
